(19) United States
(12) Patent Application Publication
(10) Pub. No.: US 2024/0391061 A1
(43) Pub. Date: Nov. 28, 2024

(54) Pliers Structure

(71) Applicant: Chang-Yu Tsai, Taichung City (TW)

(72) Inventor: Chang-Yu Tsai, Taichung City (TW)

(21) Appl. No.: 18/321,853

(22) Filed: May 23, 2023

(51) Int. Cl. B25B 7/02

(52) U.S. Cl. CPC B25B 7/02; B23D 71/04

(57) ABSTRACT

A pliers structure includes a main body and a laser body mounted on the main body. The main body includes pliers, a pipe wrench, needle nose pliers, water pump pliers, a wire stripper, electrician pliers, universal pliers, snap ring pliers, bathroom pliers, plumbing pliers, slip-joint pliers, a vise, filter pliers or car pliers. The main body is provided with an operation end. The laser body is mounted on the operation end. The laser body is formed on a whole surface or a partial surface of the operation end by a working machine during a laser process. The whole surface or partial surface of the operation end is provided with a friction face formed by the laser process, including peeling, coloring, concentration, or carbonization. The friction face is a rough surface with particles to increase the friction force is use.

### BACKGROUND OF THE INVENTION

### Field of the Invention

The present invention relates to a hand tool and, more particularly, to a pliers structure.

### Description of the Related Art

A conventional hand tool was disclosed in the U.S. Pat. No. 8,020,473, and comprises a main body 10, at least one second body 20, and a cover 40. The main body 10 is a handle and is provided with at least one slot 11 and an opening 111. The at least one second body 20 is mounted in the at least one slot 11 and is provided with a grinding face 21. The cover 40 seals the at least one second body 20 in the at least one slot 11. When the main body 10 contacts an oily liquid, such as engine oil, lubricating oil, etc., in the workplace, the main body 10 easily slips from the workpiece, thereby causing inconvenience to the operator. The grinding face 21 provides an anti-slip function to increase the friction between the main body 10 and the workpiece so that the main body 10 will not slip from the workpiece during operation. However, the grinding face 21 only provides an anti-slip function and cannot increase the function of the main body 10, thereby limiting the versatility of the hand tool.

### BRIEF SUMMARY OF THE INVENTION

In accordance with the present invention, there is provided a pliers structure comprising a main body and a laser body mounted on the main body. The main body includes pliers, a pipe wrench, needle nose pliers, water pump pliers, a wire stripper, electrician pliers, universal pliers, snap ring pliers, bathroom pliers, plumbing pliers, slip-joint pliers, a vise, filter pliers, car pliers, clamp pliers or a clip. The main body is provided with an operation end. The laser body is mounted on the operation end. The laser body is formed on a whole surface or a partial surface of the operation end by a working machine during a laser process. The whole surface or partial surface of the operation end is provided with a friction face formed by the laser process, including peeling, coloring, concentration, or carbonization. The friction face is a rough surface with particles to increase the friction force is use.

According to the primary advantages of the present invention, the friction face increases the friction force between the operation end and the workpiece when contacting, to prevent the workpiece from slipping from the operation end. The surface of the operation end is provided with the laser body. When the workpiece produces burrs, the laser body on the main body is used as a grinding tool to remove the burrs on the workpiece without having to use or purchase a sander, thereby saving the working time.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pliers structure in accordance with the first preferred embodiment of the present invention.

FIG. 2 is a front view of an operation end of the pliers structure of the present invention.

FIG. 3 is a perspective view of a pliers structure in accordance with the second preferred embodiment of the present invention.

FIG. 4 is a perspective view of a pliers structure in accordance with the third preferred embodiment of the present invention.

FIG. 5 is a perspective view of a pliers structure in accordance with the fourth preferred embodiment of the present invention.

FIG. 6 is a perspective view of a pliers structure in accordance with the fifth preferred embodiment of the present invention.

FIG. 7 is a perspective view of a pliers structure in accordance with the sixth preferred embodiment of the present invention.

FIG. 8 is a perspective view of a pliers structure in accordance with the seventh preferred embodiment of the present invention.

FIG. 9 is a perspective view of a pliers structure in accordance with the eighth preferred embodiment of the present invention.

FIG. 10 is a perspective view of a pliers structure in accordance with the ninth preferred embodiment of the present invention.

FIG. 11 is a perspective view of a pliers structure in accordance with the tenth preferred embodiment of the present invention.

FIG. 12 is a perspective view of a pliers structure in accordance with the eleventh preferred embodiment of the present invention.

FIG. 13 is a perspective view of a pliers structure in accordance with the twelfth preferred embodiment of the present invention.

FIG. 14 is a perspective view of a pliers structure in accordance with the thirteenth preferred embodiment of the present invention.

FIG. 15 is a perspective view of a pliers structure in accordance with the fourteenth preferred embodiment of the present invention.

FIG. 16 is a perspective view of a pliers structure in accordance with the fifteenth preferred embodiment of the present invention.

### DETAILED DESCRIPTION OF THE INVENTION

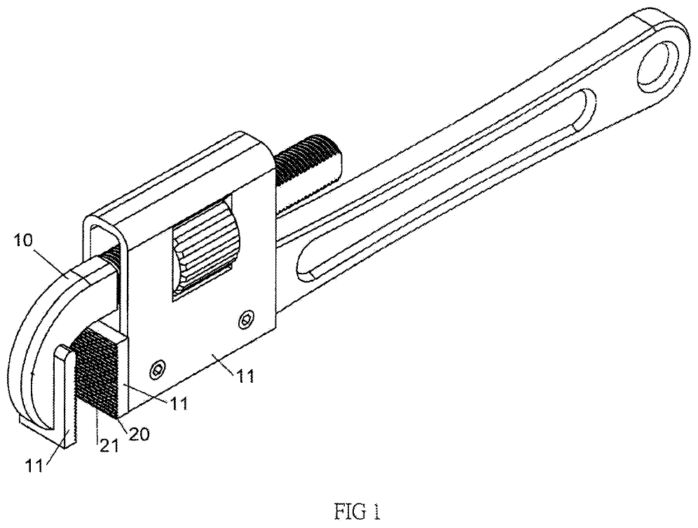

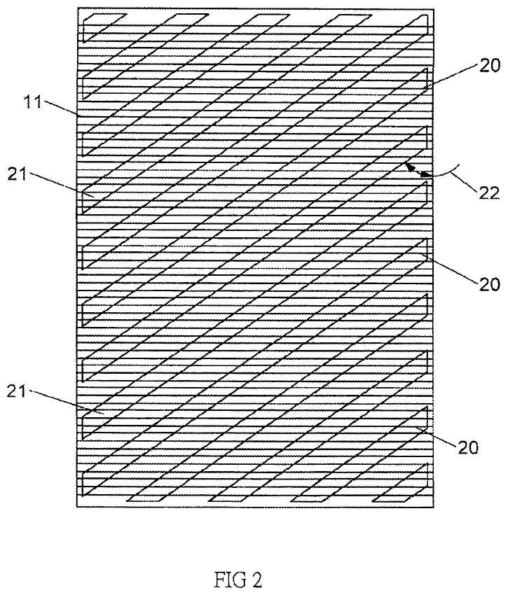

Referring to the drawings and initially to FIGS. 1 and 2, a pliers structure in accordance with the preferred embodiment of the present invention comprises a main body 10 and a laser body 20 mounted on the main body 10.

The main body 10 includes pliers, a pipe wrench, needle nose pliers, water pump pliers, a wire stripper, electrician pliers, universal pliers, snap ring pliers, bathroom pliers, plumbing pliers, slip-joint pliers, a vise, filter pliers, car pliers, clamp pliers or a clip.

The main body 10 is provided with an operation end (or an active end or a working end) 11. The operation end 11 is a surface contacting another element. The operation end 11 is a surface contacting a workpiece. The operation end 11 is a surface for rotating a workpiece. The operation end 11 is a clamping portion for clamping various workpieces. The operation end 11 is provided with a toothed portion. The toothed portion includes multiple teeth. The multiple teeth are arranged in a straight direction or in a transverse direction.

The laser body 20 is mounted on the operation end 11. The laser body 20 is formed on a whole surface or a partial surface of the operation end 11 by a working machine during a laser process. The whole surface or partial surface of the operation end 11 is provided with a friction face 21 formed by the laser process, including peeling, coloring, concentration, or carbonization. The friction face 21 is a rough surface with particles. The friction face 21 increases a contact friction force between the operation end 11 and the workpiece to prevent the workpiece from slipping from the operation end 11.

The laser process includes diverse methods and will not be described in detail. The operation end 11 is provided with the laser body 20, and the friction face 21 of the laser body 20 is formed by the laser process.

The laser body 20 is provided on a surface of the operation end 11. The friction face 21 is served as the surface of the operation end 11. The friction face 21 covers at least one third (⅓) of the surface of the operation end 11.

Multiple friction faces 21 are provided on the partial surface of the operation end 11 as shown in FIG. 2.

The friction faces 21 are arranged obliquely relative to the operation end 11. An angle 22 is defined between each of the friction faces 21 and a side face of the operation end 11. The angle 22 is ranged between ten (10) degrees and seventy (70) degrees, or ranged between fifteen (15) degrees and sixty (60) degrees. The angle 22 is optimally close to fifty-five (55) degrees.

Alternatively, the friction faces 21 are arranged linearly relative to the operation end 11 so that the friction faces 21 and the operation end 11 are parallel mutually. Alternatively, the friction faces 21 are arranged transversely relative to the operation end 11.

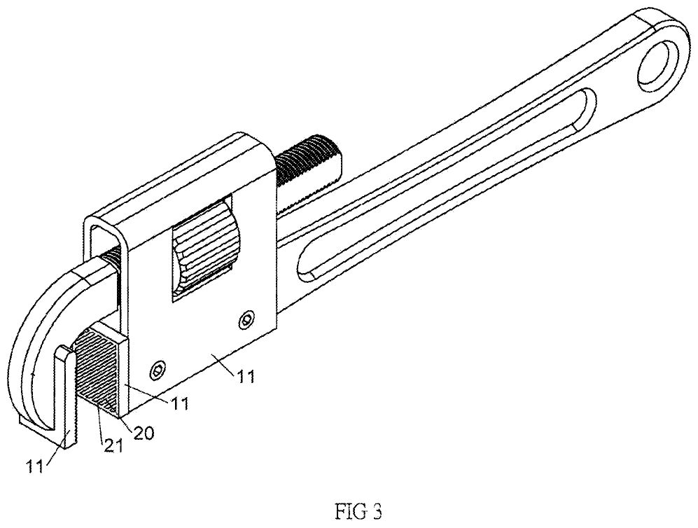

Referring to FIG. 3 with reference to FIGS. 1 and 2, the operation end 11 of the main body 10 has a planar shape. Thus, the operation end 11 is not provided with a toothed portion. Alternatively, the operation end 11 is a concave face, a convex face, or a curved face.

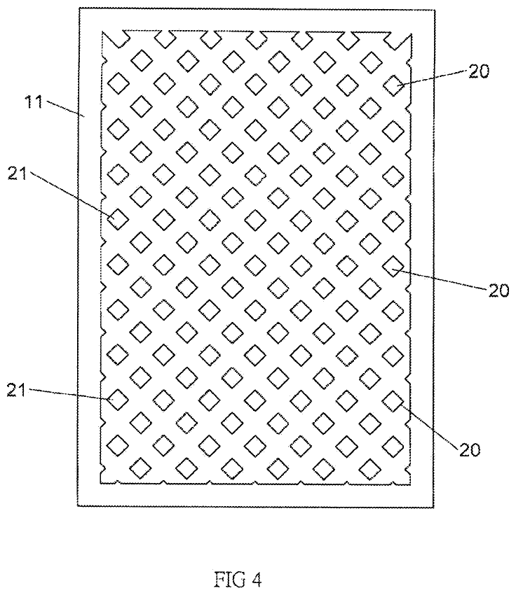

Referring to FIG. 4, the friction faces 21 have a dot arrangement structure. The friction faces 21 are arranged in a matrix manner.

Again, referring to FIG. 1, the main body 10 functions as a pipe wrench or pipe pliers.

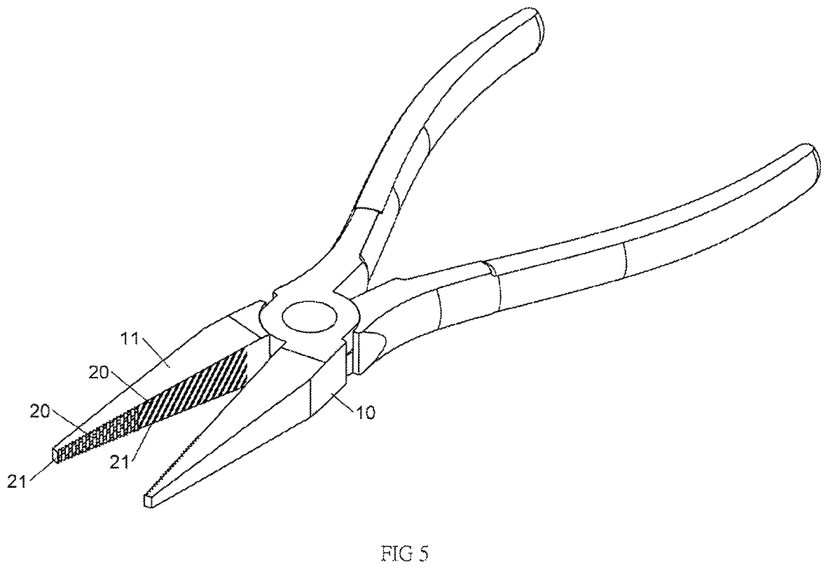

Referring to FIG. 5, the main body 10 functions as needle nose pliers.

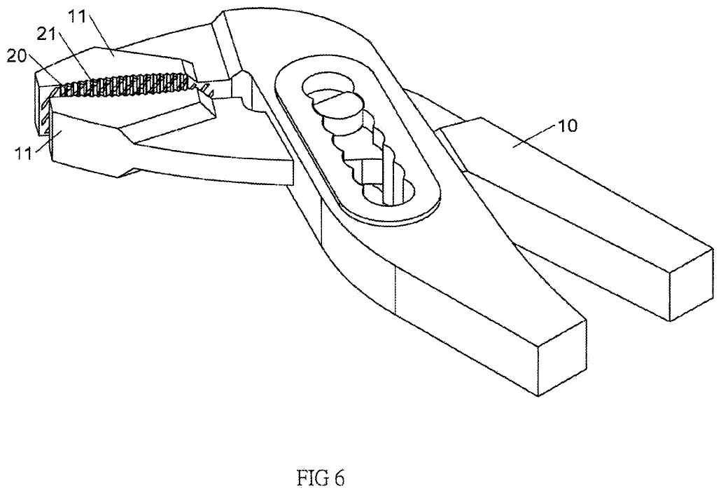

Referring to FIG. 6, the main body 10 functions as water pump pliers.

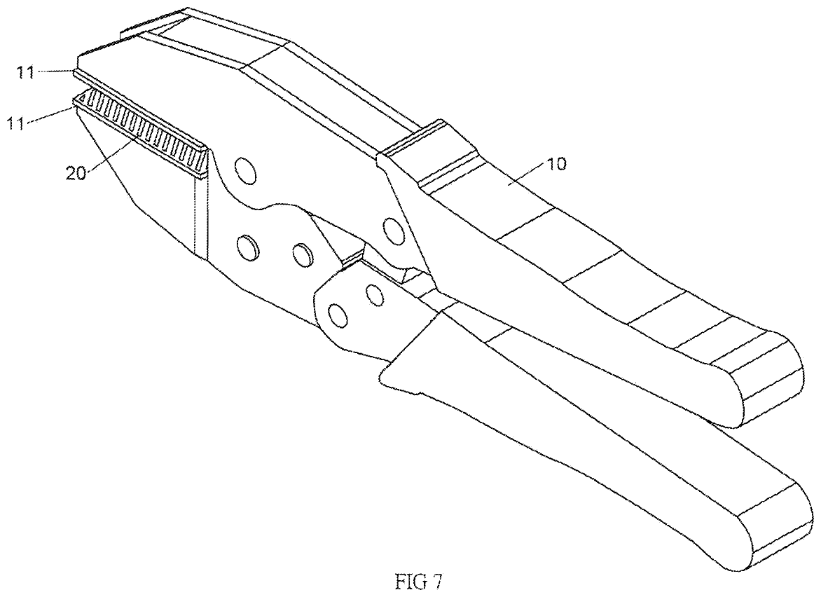

Referring to FIG. 7, the main body 10 functions as electrician pliers or a wire stripper.

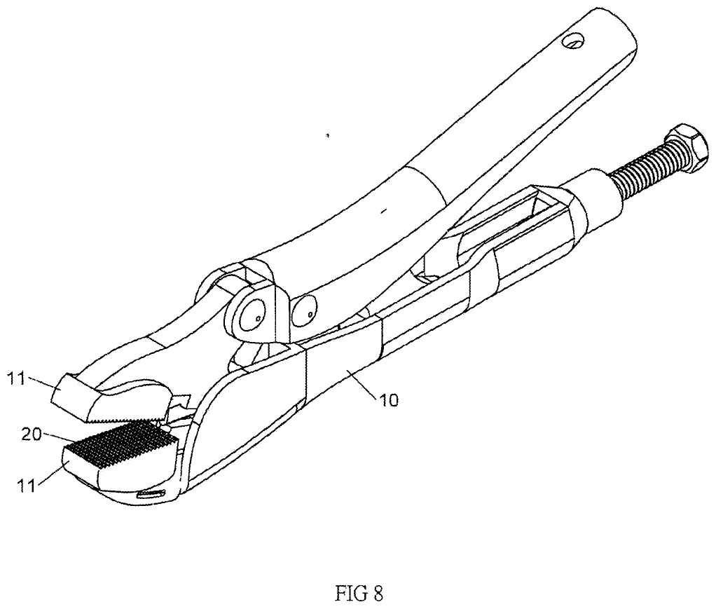

Referring to FIG. 8, the main body 10 functions as universal pliers, and the operation end 11 is provided with a toothed portion.

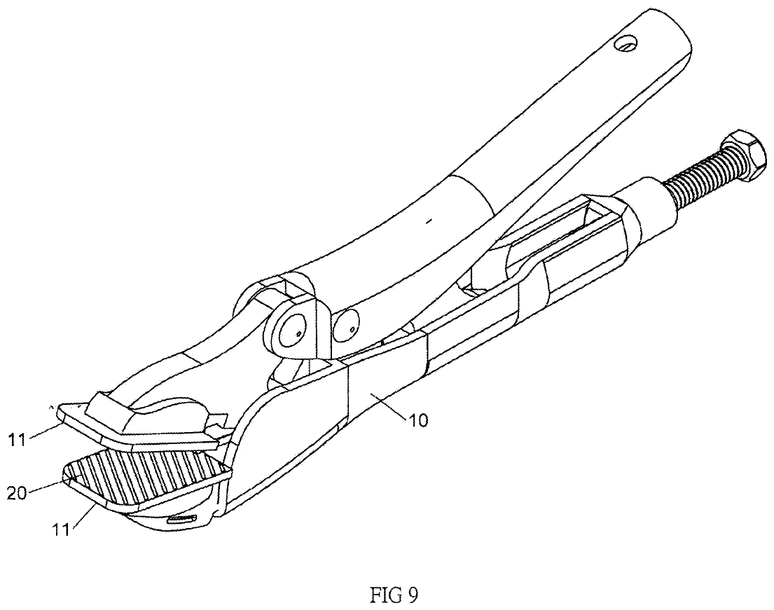

Referring to FIG. 9, the main body 10 functions as universal pliers, and the operation end 11 is not provided with a toothed portion.

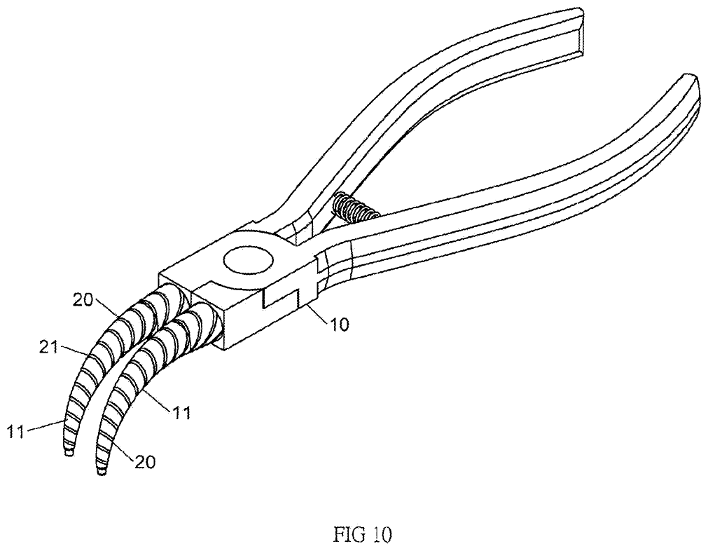

Referring to FIG. 10, the main body 10 functions as snap ring pliers.

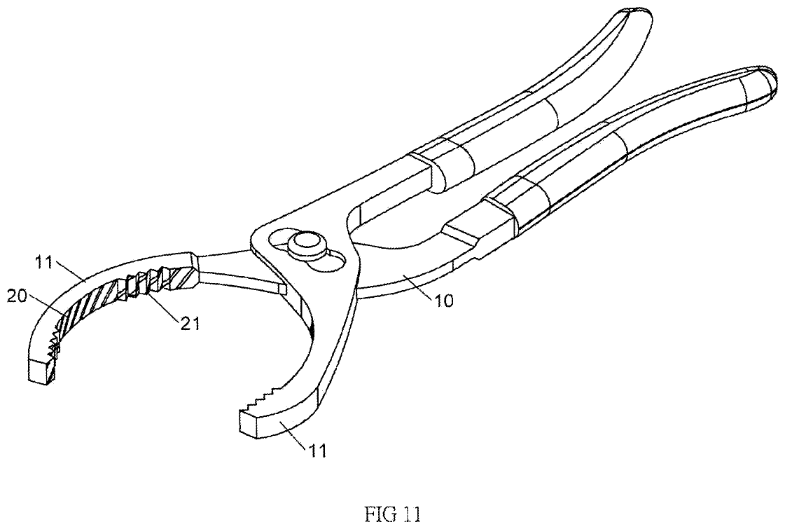

Referring to FIG. 11, the main body 10 functions as bathroom pliers or plumbing pliers.

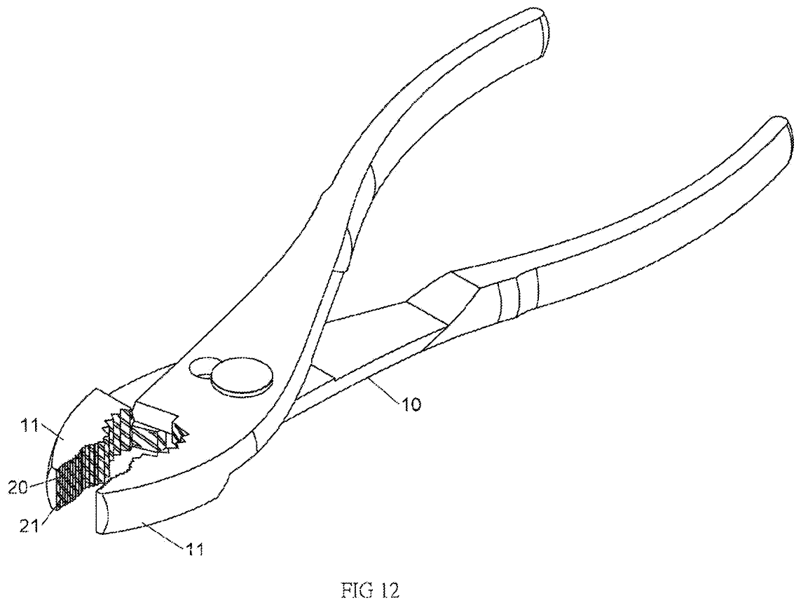

Referring to FIG. 12, the main body 10 functions as slip-joint pliers.

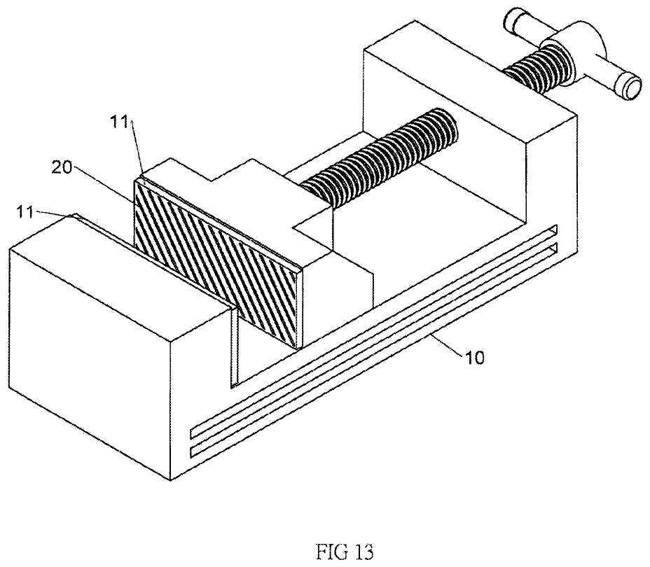

Referring to FIG. 13, the main body 10 functions as a vise.

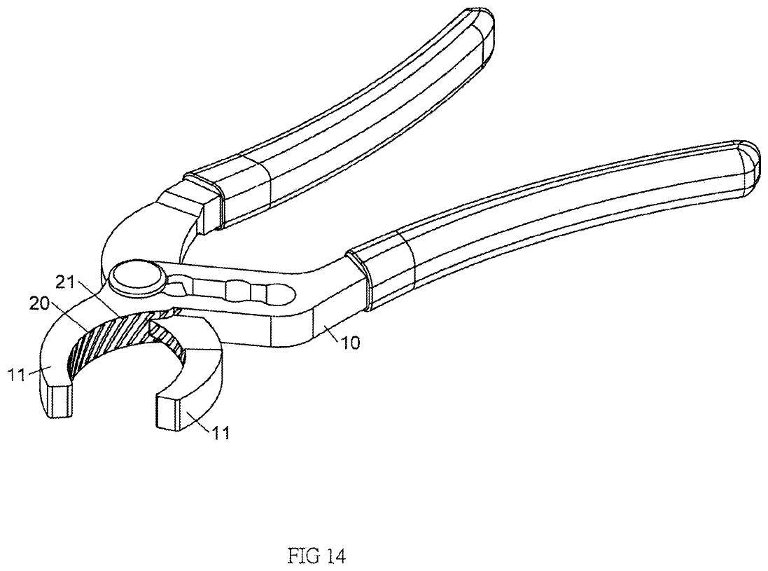

Referring to FIG. 14, the main body 10 functions as filter pliers or car pliers.

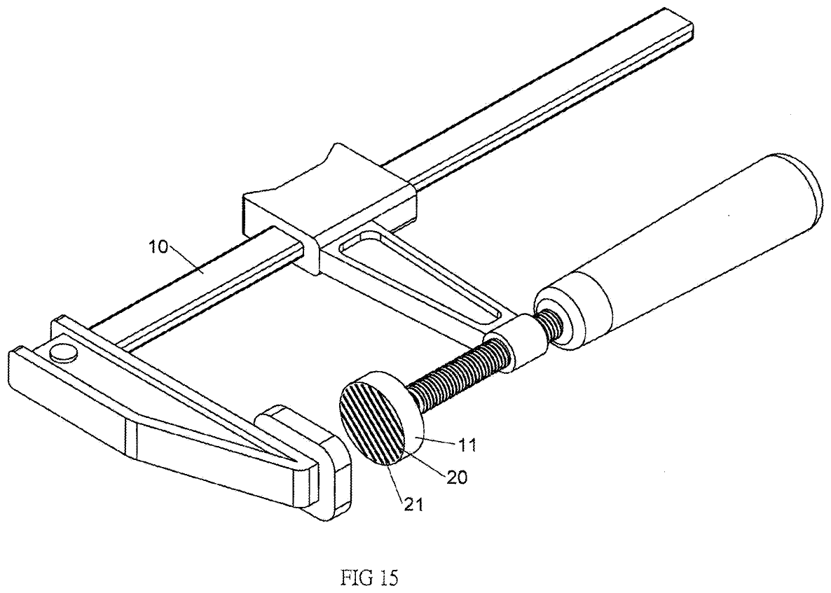

Referring to FIG. 15, the main body 10 functions as clamp pliers.

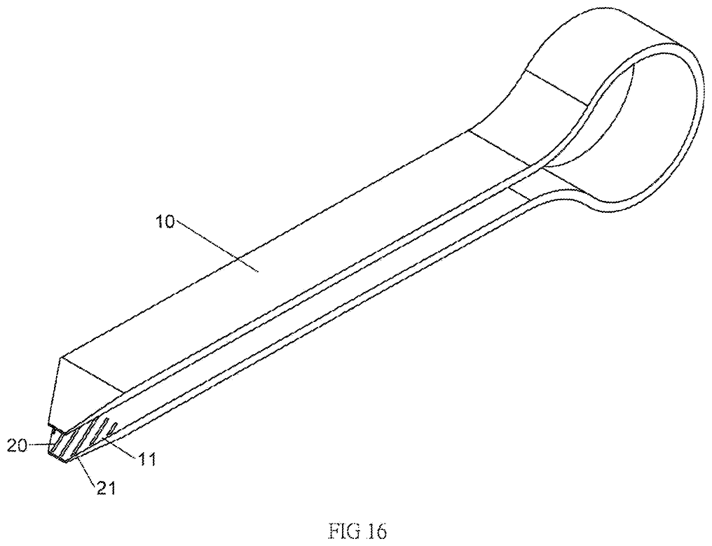

Referring to FIG. 16, the main body 10 functions as a clip.

Accordingly, the pliers structure of the present invention has the following advantages.

1. The operation end 11 may be provided with a toothed portion to increase the friction force during rotation. When the surface of the workpiece has low hardness, the operation end 11 will engage and wear the surface of the workpiece. At this time, the laser body 20 is mounted on the toothed surface of the operation end 11 as shown in FIG. 1 to increase the friction force. Alternatively, the laser body 20 is mounted on the planar surface of the operation end 11 as shown in FIG. 3 to increase the friction force. Thus, the main body 10 is used to rotate the workpiece with low hardness. The operation end 11 is provided with or not provided with the toothed portion according to different working conditions.

2. The friction face 21 increases the friction force between the operation end 11 and the workpiece when contacting, to prevent the workpiece from slipping from the operation end 11.

3. The surface of the operation end 11 without the toothed portion is provided with the laser body 20. When the workpiece produces burrs, the laser body 20 on the main body 10 is used as a grinding tool to remove the burrs on the workpiece without having to use or purchase a sander, thereby saving the working time.

4. When the operation end 11 contacts an oily liquid, such as engine oil, lubricating oil, etc., in the workplace, the operation end 11 easily slips from the workpiece, thereby causing inconvenience to the operator. The friction face 21 is made by the laser process and provides an anti-slip function to increase the friction resistance during operation of the operation end 11.

5. The friction face 21 of the laser body 20 is provided with colors, characters, or figures to increase identification of the operation end 11.

6. The operation end 11 is provided with the friction face 21 so that the pliers structure has the maximum friction force.

7. The friction face 21 is provided on the main body 10 through a predetermined path set by a program. The laser body 20 is made by a conventional method. Thus, the main body 10 is provided with the laser body 20 to decrease the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A pliers structure comprising:
a main body; and
a laser body mounted on the main body;
wherein:
the main body includes pliers, a pipe wrench, needle nose pliers, water pump pliers, a wire stripper, electrician pliers, universal pliers, snap ring pliers, bathroom pliers, plumbing pliers, slip-joint pliers, a vise, filter pliers, car pliers, clamp pliers or a clip;
the main body is provided with an operation end;
the operation end is a surface contacting another element;
the operation end is a surface contacting a workpiece;
the operation end is a surface for rotating a workpiece;
the operation end is a clamping portion for clamping various workpieces;
the laser body is mounted on the operation end;
the laser body is formed on a whole surface or a partial surface of the operation end by a working machine during a laser process;
the whole surface or partial surface of the operation end is provided with a friction face formed by the laser process, including peeling, coloring, concentration, or carbonization;
the friction face is a rough surface with particles;
the friction face increases a contact friction force between the operation end and the workpiece to prevent the workpiece from slipping from the operation end;
the laser body is provided on a surface of the operation end;
the friction face is served as the surface of the operation end;
the friction face covers at least one third (⅓) of the surface of the operation end;
multiple friction faces are provided on the partial surface of the operation end;
the friction faces are arranged obliquely relative to the operation end;
an angle is defined between each of the friction faces and a side face of the operation end;
the angle is ranged between ten (10) degrees and seventy (70) degrees, or ranged between fifteen (15) degrees and sixty (60) degrees;
the angle is optimally close to fifty-five (55) degrees;
the friction faces are arranged linearly relative to the operation end so that the friction faces and the operation end are parallel mutually; and
the friction faces are arranged transversely relative to the operation end.

2. The pliers structure as claimed in claim 1, wherein:
the operation end is provided with a toothed portion;
the toothed portion includes multiple teeth; and
the multiple teeth are arranged in a straight direction or in a transverse direction.

3. The pliers structure as claimed in claim 1, wherein the operation end is provided with the laser body, and the friction face of the laser body is formed by the laser process.

4. The pliers structure as claimed in claim 1, wherein:
the operation end of the main body has a planar shape; and
the operation end is a concave face, a convex face, or a curved face.

5. The pliers structure as claimed in claim 1, wherein:
the friction faces have a dot arrangement structure; and
the friction faces are arranged in a matrix manner.
